(19) United States
(12) Patent Application Publication
(10) Pub. No.: US 2022/0134224 A1
(43) Pub. Date: May 5, 2022

(54) GAME SYSTEM, PROGRAM AND INFORMATION PROCESSING METHOD

(71) Applicant: Akatsuki Inc., Tokyo (JP)

(72) Inventor: Sho HONDA, Tokyo (JP)

(21) Appl. No.: 17/472,208

(22) Filed: Sep. 10, 2021

(30) Foreign Application Priority Data
Nov. 2, 2020 (JP) 2020-183457

(51) Int. Cl. A63F 13/497; A63F 13/79; A63F 13/69

(52) U.S. Cl. CPC A63F 13/497; A63F 13/69; A63F 13/79

(57) ABSTRACT

To provide a game system, a program, and an information processing method that can improve the convenience of a user when executing a game, in a game system that provides a game that can be executed by a plurality of user terminals capable of accessing a server via a network, a bookmark processing unit that registers an arbitrary screen in the game as a bookmark is provided.

### TECHNICAL FIELD

The present invention relates to a game system, a program and an information processing method, and more particularly, to a game system, a program and an information processing method, which provide a game that can be executed on a plurality of user terminals capable of accessing a server via a network.

### BACKGROUND ART

In recent years, games that can be executed on user terminals such as smartphones or game terminals capable of accessing a server via a network have been provided. When executing this type of game, it may be necessary to retrieve a desired game from a plurality of application programs stored in the user terminal.

Patent Literature 1 discloses a system implemented with a bookmark function that adds, to a home screen of a smartphone, a shortcut icon capable of permitting access to a top screen of an arbitrary game.

### PRIOR ART

### Patent Literature

Patent Literature 1: Japanese Unexamined Patent Publication No. 2019-91478

### SUMMARY OF THE INVENTION

### Technical Problem

Some games which can be executed on a user terminal are provided with a plurality of modes, such as progressing a game by a fighting or the like, executing preset events, and growing characters used by a user as a player.

In these types of games, when transition is made from the currently executing mode to another mode, it may be necessary to return, for example, up to the mode selection screen capable of selecting the mode, and then select another desired mode.

If this is the case, there is a concern that the convenience of the game is impaired in that when transition is made from the currently executing mode to another mode, the labor or burden of returning to the mode selection screen is applied to the user.

Meanwhile, even in the case of the same mode or in the case of a game that does not have a plurality of modes, for example, it may require execution of repeated actions in an event. Even in such a case, there is a concern that the convenience in the game is impaired in that the labor or burden of returning to an arbitrary screen in the event is applied to the user.

The present invention has been made in view of the above-mentioned circumstances, and an object of the present invention is to provide a game system, a program, and an information processing method that can improve the convenience of a user when executing a game.

### Technical Solution

The game system according to the present invention for achieving the above object is a game system which provides a game that can be executed on a plurality of user terminals capable of accessing a server via a network, wherein the game system comprises a bookmark processing unit that registers an arbitrary screen in the game as a bookmark.

The screen in the game of this game system comprises a screen displayed in any mode selected from a plurality of modes in which different functions are executed in the game.

According to this, by registering any screen as a bookmark, even if the mode of the screen registered as a bookmark is different from the mode of the current screen, transition can be made from the current screen to the screen registered as a bookmark, without a labor of returning up to the screen selecting the screen mode registered as a bookmark, or of going back against the progress of the game and returning screens one by one by one to the screen registered as a bookmark.

Therefore, since the number of operations when transitioning to the screen registered as a bookmark is reduced, the convenience of a user when executing the game is improved.

The bookmark processing unit of the game system is characterized by giving a label to the screen registered as a bookmark, and the label has a plurality of design labels, each with a plurality of designs that are different from each other, and the design label is given when a pre-set condition is achieved in the game.

In addition, the game system is characterized by including a reward imparting unit that imparts an in-game reward to a player operated by a user via a user terminal when a pre-set screen is registered as a bookmark.

This in-game reward is characterized by including at least one of: execution of events that are executed in the game, increase in a drop rate, which indicates the probability of acquiring an item given to a player, and function execution command to release the restriction and execute the function when the in-game points that can be consumed in the game and the functions executed in the game are limited.

The game system is characterized in that a sub-event is executed in the game when the screen registered as a bookmark is transitioned via the bookmark.

The program according to the present invention for achieving the above object is a program which executes a game on a plurality of user terminals capable of accessing a server via a network, wherein the program is characterized by executing a bookmark processing to register an arbitrary screen in the game as a bookmark.

The information processing method according to the present invention for achieving the above object is an information processing method which executes a game on a plurality of user terminals capable of accessing a server via a network, wherein the method is characterized by executing a bookmark processing for registering an arbitrary screen in the game as a bookmark.

### Advantageous Effects

According to the present invention, the convenience of a user when executing a game is improved.

### BRIEF DESCRIPTION OF THE DRAWING

FIG. 1 is a block diagram illustrating an outline of a configuration of a game system according to an embodiment of the present invention.

FIG. 2 is a block diagram illustrating an outline of a server configuration of a game system according to this embodiment as well.

FIG. 3 is a block diagram illustrating an outline of a storage configuration of a server of a game system according to this embodiment as well.

FIG. 4 is a block diagram illustrating an outline of a configuration of game information processed by a game system according to this embodiment as well.

FIG. 5 is a block diagram illustrating an outline of processing in a game processing unit of an information processing program of a game system according to this embodiment as well.

FIG. 6 is a block diagram illustrating an outline of processing in the game processing unit of the information processing program of the game system according to this embodiment as well.

FIG. 7 is showing an example of a game screen of the game system according to this embodiment as well.

FIG. 8 is showing an example of a game screen of the game system according to this embodiment as well.

FIG. 9 is showing an example of a game screen of the game system according to this embodiment as well.

FIG. 10 is a block diagram illustrating an outline of a configuration of a user terminal of a game system according to this embodiment as well.

FIG. 11 is a flowchart illustrating an outline of processing of the game system according to this embodiment as well.

### DETAILED DESCRIPTION OF THE EMBODIMENTS

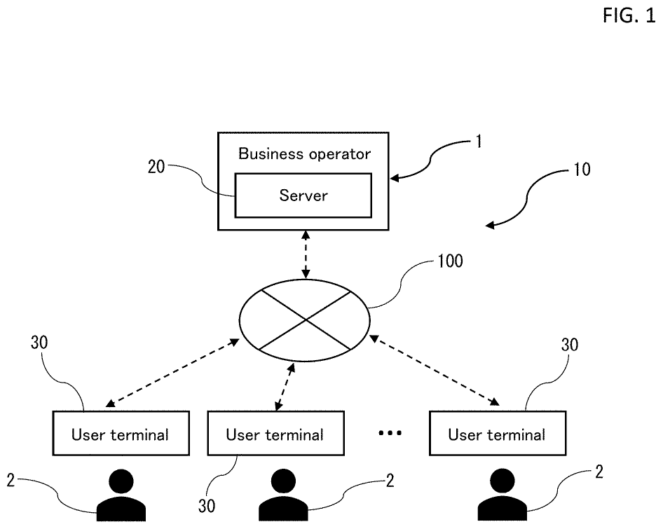

Next, the game system according to the embodiment of the present invention will be described with reference to FIGS. 1 to 11.

FIG. 1 is a block diagram illustrating an outline of a configuration of a game system according to an embodiment of the present invention. As shown in the figure, the game system 10 includes a server 20 and a plurality of user terminals 30 as a main configuration, and these are connected to each other so as to be accessible via a network 100 such as an Internet network.

In this embodiment, the server 20 is arranged in a business operator 1 that provides a game in the game system 10, and the user terminal 30 is owned by a plurality of users 2 who uses a game provided by a business operator 1.

The game provided by the business operator 1 in the game system 10 is not particularly limited, and for example, is assumed to be various games, such as fighting/competition games, puzzle games, action games, baseball games, soccer games, other sports games, quiz games, pinball games, card games, rhythm games, RPGs (role-playing games), location-based games, board games, adventure games, casino games, simulation games, strategy games, racing games, and the like.

Next, a specific configuration of each part of the game system 10 of this embodiment will be described.

In this embodiment, the server 20 is implemented by a desktop computer or a notebook computer.

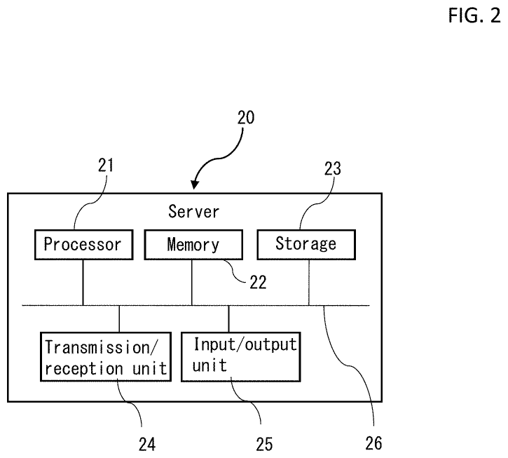

FIG. 2 is a block diagram illustrating an outline of a configuration of a server 20. As shown in the figure, the server 20 includes a processor 21, a memory 22, a storage 23, a transmission/reception unit 24, and an input/output unit 25, which are electrically connected to each other via a bus 26.

The processor 21 is an arithmetic device that controls the operation of the server 20, controls the transmission/reception of data between respective elements, and performs the processing necessary for executing an application program.

In this embodiment, the processor 21 is, for example, a CPU (Central Processing Unit), and performs each processing by executing an application program stored in the storage 23 described later and deployed in the memory 22.

The memory 22 includes a main storage device configured of a volatile storage device such as a DRAM (Dynamic Random Access Memory), and/or an auxiliary storage device configured of a non-volatile storage device such as a flash memory and/or an HDD (Hard Disk Drive).

While it is used as a working area of the processor 21, the memory 22 stores the BIOS (Basic Input/Output System) executed at the starting of the server 20, various setting information, and the like.

The storage 23 stores information and the like used for programs and various processes. The configuration of the storage 23 will be described later.

The transmission/reception unit 24 connects the server 20 to a network 100. The transmission/reception unit 24 may be provided with a short-range communication interface such as Bluetooth (registered trademark) or BLE (Bluetooth Low Energy).

The input/output unit 25 is an interface to which an input/output device such as a keyboard, a mouse, or a display is connected.

The bus 26 transmits, for example, an address signal, a data signal, and various control signals between the connected processor 21, memory 22, storage 23, transmission/reception unit 24, and input/output unit 25.

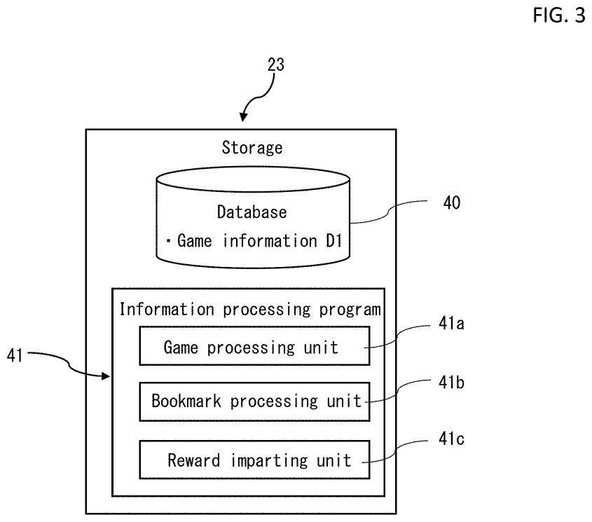

FIG. 3 is a block diagram illustrating an outline of a configuration of a storage 23. As shown in the figure, in this embodiment, the storage 23 includes a database 40 and an information processing program 41.

The database 40 is implemented as a storage area provided by the storage 23, and in this embodiment, a game information D1 is stored.

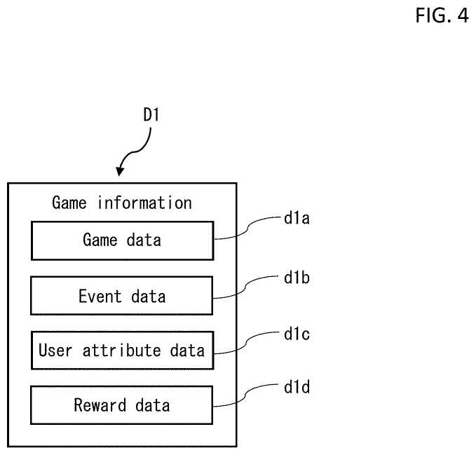

FIG. 4 is a block diagram illustrating an outline of a configuration of the game information D1. As shown in the figure, the game information D1 includes a game data d1a, an event data d1b, a player data d1c, and a reward data d1d.

In this embodiment, the game data d1a is configured of a data related to the setting of a game according to the type of game, such as a character or an item, a background screen, or the like which appear in the game. For example, in the case of a fighting/competition game, the stage name and the like associated with a stage ID are included.

In this embodiment, the character constituting the game data d1a includes a player in the game by a user 2 operating via a user terminal 30, a character which is a friend of the player, or an enemy character who plays against the player, and the like.

In this embodiment, the event data d1b is configured of an arbitrary event in which a trial (e.g., fighting with an enemy character) is set for the user 2 to execute as a player. When this type of event is cleared, in-game rewards described later, such as items used in the game or recovery of the player's energy may be granted.

In this embodiment, the player data d1c is configured of a player name, data related to a character owned by a user 2 as a player, data related to an item owned by a player of a user 2, data related to a play stage, and the like.

The data related to the owned character includes, for example, the current values of various parameters, such as the level, attack power, defense power, and physical strength which are associated with the ID of the character.

The data related to the owned item includes, for example, a value such as the number of possession of items which are associated with the item ID.

The data related to the play stage is the data related to the stage that the user 2 has played as a player among a plurality of set stages, and for example, includes the number of plays or the data when the stage is cleared.

The reward data d1d is data related to the in-game reward granted to the player.

In this embodiment, the in-game reward includes, for example, execution of an arbitrary event that is executed in the game, increase in a drop rate, which indicates the probability that the player will acquire any item, in-game points consumed when exchanging for items in the game and restoring the player's energy, and the like, or, if a function executed in the game is limited, a function execution command to lift the restriction and execute the function, and the like.

In this embodiment, the information processing program 41 shown in FIG. 3 includes a game processing unit 41a, a bookmark processing unit 41b, and a reward imparting unit 41c.

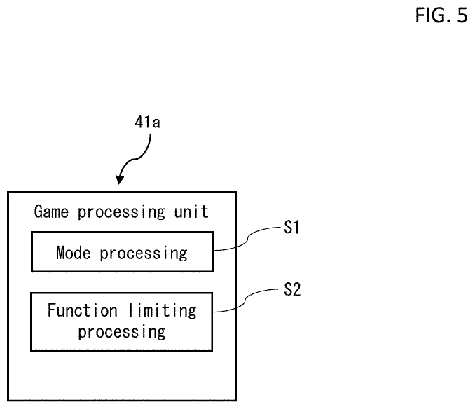

FIG. 5 is also a block diagram illustrating an outline of processing in a game processing unit of an information processing program of a game system according to this embodiment. The game processing unit 41a is a module that executes basic processing of a game, such as progress of a game or control of a character. In the present embodiment, it executes mode processing S1 and function limiting processing S2 as shown in the figure.

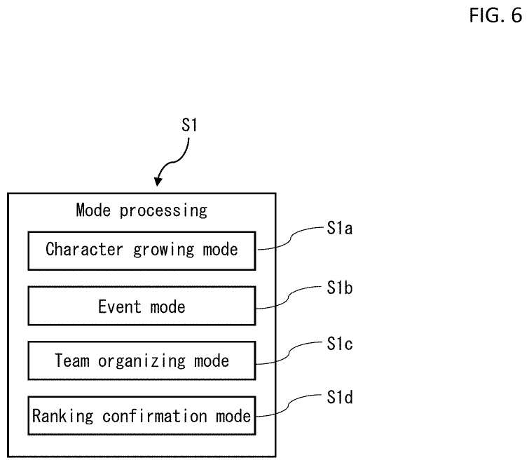

FIG. 6 is a block diagram illustrating an outline of the mode processing S1. As shown in the figure, in the mode process S1, a character growing mode S1a, an event mode S1b, a team organizing mode S1c, and a ranking confirmation mode S1d are executed.

In this embodiment, the character growing mode S1a is a mode in which the character's experience and energy values are improved, for example, by forcing the character running or swimming selected by the user 2 as the player, thereby executing the character growth.

In this embodiment, the event mode S1b is a mode in which the event processing is executed according to the action of a character selected by a user 2 as a player.

In this embodiment, the team organizing mode S1c is a mode which executes the selection of the player of the user 2 and the character organizing the team, and the selection of the team when a plurality of teams organizing the team with the player of the user 2 are present.

In this embodiment, the ranking confirmation mode S1d is a mode which confirms the ranking among a plurality of characters selected by a user 2 as a player or confirms the ranking to with a character selected by another user 2 as a player.

In this embodiment, a function limiting processing S2 shown in FIG. 5 executes the processing of limiting a function executed in the game and lifting the restriction.

In this embodiment, the game is executed on the user terminal 30 based on the mode processing S1 and the function limiting processing S2 in the game processing unit 41a.

In this embodiment, the bookmark processing unit 41b shown in FIG. 3 is a module that registers a screen in the game as a bookmark, gives a label to the registered screen, and executes a transition to the registered screen, and at the same time, executes a sub-event under appropriate conditions at the time of the transition.

In this embodiment, the bookmark processing unit 41b is implemented on a game screen that is displayed on the user terminal 30 and allows input and output of information via a user terminal 30.

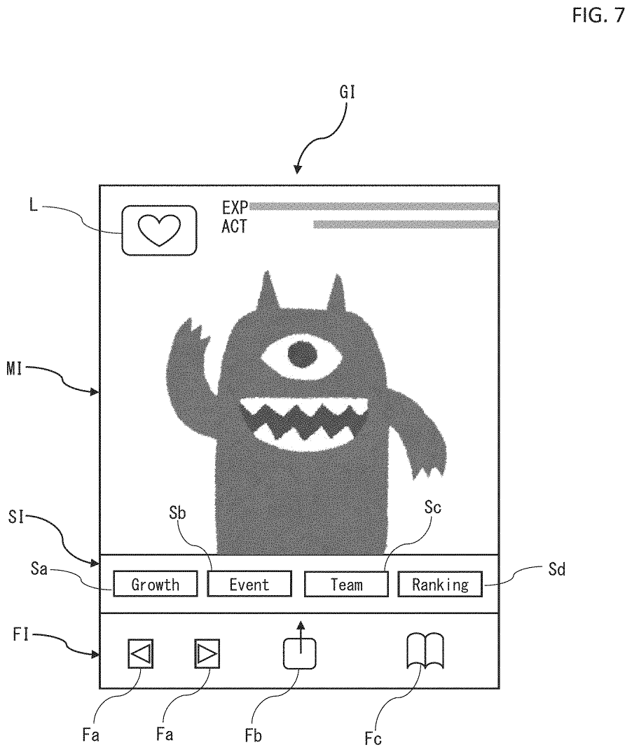

FIG. 7 is showing an example of a game screen. As shown in the figure, the game screen GI includes a main screen MI, a mode selection screen SI, and a function screen FI as main configurations.

In this embodiment, the main screen MI is an area in which the main elements of the game, such as characters, items, and background screens, are displayed along with the progress of a game.

The mode selection screen SI is an area in which a mode selection icon is displayed from which multiple in which different functions are executed can be selected. In this embodiment, the mode selection icon includes a growth icon Sa, an event icon Sb, a team icon Sc, and a ranking icon Sd.

In this embodiment, the growth icon Sa, the event icon Sb, the team icon Sc, and the ranking icon Sd are icons that execute a character growing mode S1a, an event mode S1b, a team organizing mode S1c, and a ranking confirmation mode S1d, respectively.

In this embodiment, the function screen FI is an area in which a game operation icon Fa, a bookmark registration icon Fb, and a bookmark display icon Fc are displayed.

In this embodiment, the game operation icon Fa is an icon related to the operation of the player selected by a user 2.

In this embodiment, the bookmark registration icon Fb is an icon which registers an arbitrary screen in the game as a bookmark based on the request of the user 2. In this embodiment, when an arbitrary screen is registered as a bookmark with the bookmark registration icon Fb, a label L is given to the screen registered by the bookmark processing unit 41b.

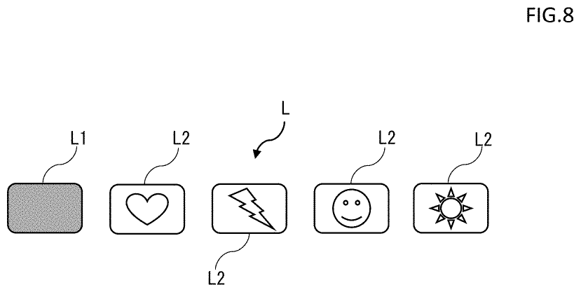

FIG. 8 is illustrating an example of the label L. As shown in the figure, in this embodiment, the label L is configured of a color label L1 subjected to arbitrary coloring and a plurality of design labels L2 to which a plurality of different designs is given.

In this embodiment, the label L is given to the color label L1 at the initial setting, but for example, it is given a design label L2 when a pre-set condition is achieved in the game, such as, for example, clearing an event or improving the character growing level.

By preparing a plurality of design labels L2 to which a plurality of different designs is given, respectively, in this way, the user 2 can use these design labels L2 as a collecting element, so that interest of user 2 in the game is improved.

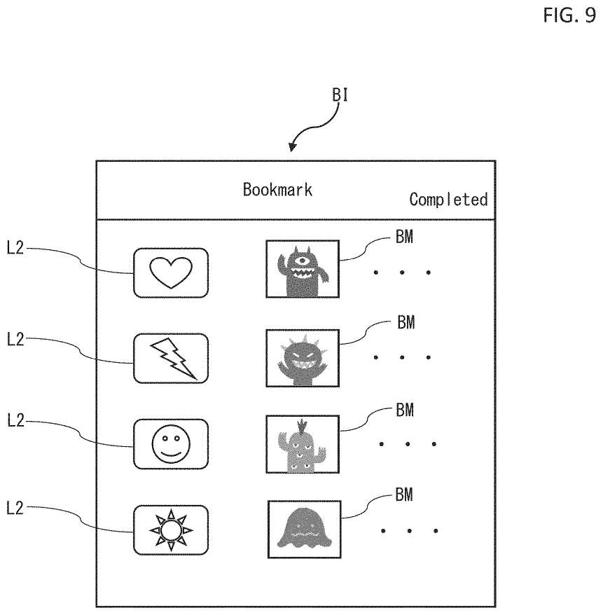

In this embodiment, the bookmark display icon Fc shown in FIG. 7 is an icon which displays a list of arbitrary screens registered as bookmarks as bookmark screens. In this embodiment, as shown in FIG. 9, the bookmark screen BI is displayed in association with the screen registered as the bookmark BM and the label L given to the screen.

When an arbitrary screen registered as a bookmark BM is selected in this bookmark screen BI, the bookmark processing unit 41b executes a transition to the selected screen.

In addition, the bookmark processing unit 41b executes a sub-event in the game when transitioning to the screen registered as a bookmark BM via a bookmark screen BI.

In this embodiment, the sub-event presents the processing of changing the presentation of an event at the time of executing the event, or an arbitrary presentation such as the progress of a character, and then sets the processing of providing the player with a reward lower than the in-game points given as the in-game reward.

In this embodiment, the execution of the sub-event does not necessarily have to be executed when transitioning to the screen registered as a bookmark BM via a bookmark screen BI. For example, it may be configured to be executed with an arbitrary pre-set probability.

The reward imparting unit 41c shown in FIG. 3 is a module that imparts an in-game reward to a player operated by a user 2 via a user terminal 30 when a pre-set screen is registered as a bookmark BM.

In this embodiment, for example, an arbitrary screen in the character growing mode S1a executed by the growth icon Sa of the mode selection screen SI in the game screen GI shown in FIG. 7, and similarly, an arbitrary screen in the event mode S1b executed by the event icon Sb of the mode selection screen SI is set to impart an in-game reward when any one of these screens is registered as bookmark BM.

In this embodiment, the user terminal 30 shown in FIG. 1 is implemented on a smartphone, which is a portable information terminal, but for example, it may be implemented by a game dedicated terminal, a tablet computer, a desktop computer, or a notebook computer.

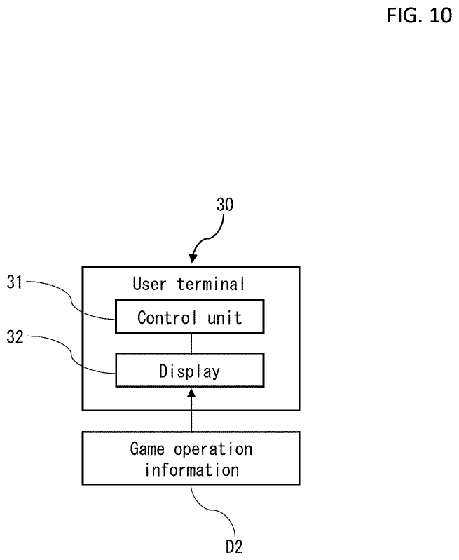

FIG. 10 is a block diagram illustrating an outline of a configuration of the user terminal 30. As shown in the figure, the user terminal 30 includes a control unit 31 and a display 32 as main configurations.

In this embodiment, the control unit 31 controls each unit of the display 32 and the user terminal 30, and for example, it is configured of a processor, a memory, a storage, a transmission/reception unit, and the like.

In this embodiment, a browser capable of browsing a game application or a website is stored in the control unit 31, and based on the processing in the game processing unit 41a of the information processing program 41 of the server 20, the game is executed on a user terminal 30 via a game application or a browser.

In this embodiment, a screen interface of the game executed on the user terminal 30 is displayed on the display 32.

The display 32 is a so-called touch panel that receives input of information by contact with the display surface, and is implemented by various techniques such as a resistance film system and an electrostatic capacitance system, and in this embodiment, game operation information D2 is to input.

The game operation information D2 is information inputted with respect to the operation or motion of the player, and is information based on the operation of the user 2 that is displayed on the game screen GI, for example, is input via a game operation icon Fa on a function screen FI.

In addition, the game operation information D2 includes information inputted with respect to registration and display of the bookmark BM, and the like, and is information based on the operation of the user 2 which is displayed on the game screen GI, for example, is inputted via the bookmark registration icon Fb or the bookmark display icon Fc on the function screen FI.

Next, the outline of the processing of the game system 10 according to this embodiment will be described.

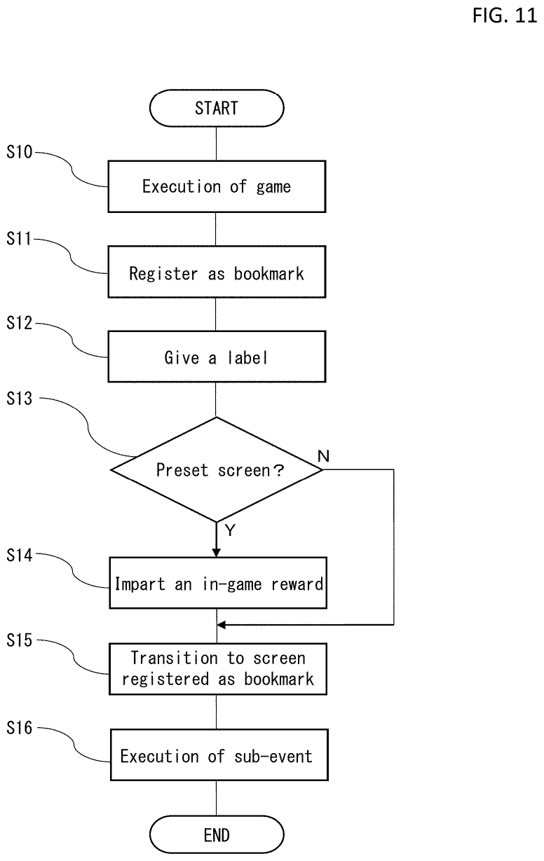

FIG. 11 is a flowchart illustrating an outline of processing of the game system 10 according to this embodiment. As shown in the figure, first, in step S10, the user 2 executes the game and progresses the game as a player.

When user 2 is expected to execute again the action on the current screen (for example, an arbitrary screen in character growing mode S1a) later in the process of progressing the game, that is, when it is determined that the screen is an important screen in the progress of the game, in step S11, the screen is registered as a bookmark BM.

In this embodiment, when an arbitrary screen is registered as a bookmark BM, the label L is given to the screen in step S12.

Subsequently, in step S13, if it is determined that the screen registered as the bookmark BM is a screen pre-set to impart an in-game reward when registered as the bookmark BM, in step S14, the in-game reward is imparted to the player of the user 2.

As an in-game reward, for example, a player who has been given in-game points can use the in-game points as requested.

After that, it is assumed that the game progresses, and transitions from an arbitrary screen in the character growing mode S1a, for example, executes an action in an arbitrary screen of the event mode S1b.

In this case, when the user 2 wants to transition from the current screen to an arbitrary screen in the character growing mode S1a registered as a bookmark BM, when selecting a bookmark BM displayed on the bookmark screen BI, in step S15, transition is made to an arbitrary screen in the character growing mode S1a registered as the bookmark BM.

By registering an arbitrary screen as a bookmark BM in this way, even if the modes of the current screen and the screen registered as the bookmark BM are different, it is possible to transition from the current screen to the screen registered as a bookmark, without the labor of returning to the screen to select the screen mode registered as a bookmark, or going back against the progress of the game and returning screens one by one by one to the screen registered as a bookmark.

Therefore, since the number of operations is reduced when transitioning to the screen registered as the bookmark BM, the convenience of the user 2 is improved when executing the game.

By the way, in this embodiment, when transitioning to the screen registered as the bookmark BM via a bookmark screen BI, the sub-event is set to be executed with an arbitrary pre-set probability.

When the transition to the screen registered as the bookmark BM in step S15 coincides with an arbitrary probability that the sub-event is executed, the sub-event is executed in step S16.

Meanwhile, in step S13, if the screen registered as the bookmark BM is not a screen pre-set to impart an in-game reward when registered as the bookmark BM, no in-game reward is imparted to the player of user 2.

The present invention is not limited to the above-mentioned embodiments, and various modifications can be made without departing from the spirit of the invention.

In the above embodiment, the case where the event execution, the drop rate improvement, the in-game point or the function execution command is given as the in-game reward has been described, but it is expected that various in-game rewards will be given, such as ranking up in the game, giving the player's life (remaining number of players, player stock), and a function to change the background screen.

In the above embodiment, although the processing of changing the presentation of an event, or the case of imparting an arbitrary reward after an arbitrary presentation has been described as the sub-event, for example, it may execute pre-processing (e.g., “skipping to a bonus stage!” is displayed) when executing a specific event, such as execution of the bonus stage.

In addition, it is possible to set an upper limit on the number of screens registered as the bookmark BM and to set a time limit when changing the registered contents of the bookmark BM.

In this case, when transitioning to the screen registered as the bookmark BM via a bookmark screen BI, it may be configured to impart an arbitrary reward (e.g., improvement of character growing level, improvement of item drop rate, etc.) according to the transition screen.

The present invention has the following configuration.

[Item 1]

A game system which provides a game that can be executed by multiple user terminals capable of accessing a server via a network,

wherein the game system comprises a bookmark processing unit that registers an arbitrary screen in the game as a bookmark.

[Item 2]

The game system as set forth in Item 1,

wherein the screen comprises a screen displayed in any of modes selected from a plurality of modes in which different functions are executed in the game.

[Item 3]

The game system as set forth in Item 1 or 2,

wherein the bookmark processing unit gives a label to the screen registered as the bookmark.

[Item 4]

The game system as set forth in Item 3,

wherein the label has a plurality of design labels to which a plurality of different designs is given, respectively, and the design label is given when the preset condition is achieved in the game.

[Item 5]

The game system as set forth in any one of Items 1 to 4,

which is provided with a reward imparting unit that imparts an in-game reward to a player operated by a user via the user terminal when the preset screen is registered as the bookmark.

[Item 6]

The game system as set forth in Item 5,

wherein the in-game reward comprises at least one selected among:

an execution of an event to be executed in the game;

an increase in a drop rate of an item, which indicates the probability of acquiring the item given to a player;

an in-game point that could be used in the game; and

a function execution command to lift a restriction and execute the function when the function to be executed in the game is restricted.

[Item 7]

The game system as set forth in any one of Items 1 to 6,

wherein a sub-event is executed in the game when a transition is made to the screen registered as the bookmark via the bookmark.

[Item 8]

A program that executes a game on a plurality of user terminals capable of accessing a server via a network,

wherein the program executes bookmark processing to register an arbitrary screen in the game as a bookmark.

[Item 9]

An information processing method for executing a game on a plurality of user terminals capable of accessing to a server via a network,

wherein the method executes a bookmark process for registering an arbitrary screen in the game as a bookmark.

### DESCRIPTION OF REFERENCE NUMERALS

1: business operator
2: user
10: game system
20: server
30: user terminal
40: database
41: information processing program
41a: game processing unit
41b: bookmark processing unit
41c: reward imparting unit
BM: bookmark
GI: game screen
L: label

1. A game system which provides a game that is executed by multiple user terminals accessing a server via a network,
wherein the game system comprises a bookmark processing unit that registers an arbitrary screen in the game as a bookmark in response to a request of a user from a user terminal, and
wherein the game system executes a sub-event in the game when transitioning to the screen registered as the bookmark via the bookmark.

2. The game system according to claim 1,
wherein the screen comprises a screen displayed in any of modes selected from among a plurality of modes in which different functions are executed in the game.

3. The game system according to claim 1 or 2,
wherein the screen gives a label to the screen registered as the bookmark.

4. The game system according to claim 3,
wherein the label has a plurality of design labels to which a plurality of different designs is given, respectively, and the design label is given when a preset condition is achieved in the game.

5. The game system as in one of claims 1-4,
which the game system further comprises a reward imparting unit that gives an in-game reward to a player operated by the user via the user terminal when the screen is registered as the bookmark.

6. The game system according to claim 5,
wherein the in-game reward comprises at least one selected from among:
an execution of an event to be executed in the game;
an increase in a drop rate of an item, which indicates the probability of acquiring the item given to the player;
an in-game point that is used in the game; and
a function execution command to lift a restriction and execute a function when the function to be executed in the game is restricted.

7. A program that executes a game on a plurality of user terminals accessing a server via a network,
wherein the program executes:
a bookmark processing to register an arbitrary screen in the game as a bookmark in response to a request of a user from a user terminal; and
a processing of executing a sub-event in the game when transitioning to the screen registered as the bookmark via the bookmark.

8. An information processing method for executing a game on a plurality of user terminals accessing a server via a network,
wherein the method executes:
a bookmark process for registering an arbitrary screen in the game as a bookmark in response to a request of a user from a user terminal; and
a processing of executing a sub-event in the game when transitioning to the screen registered as the bookmark via the bookmark.
